(19) United States
(12) Patent Application Publication
(10) Pub. No.: US 2014/0069875 A1
(43) Pub. Date: Mar. 13, 2014

(54) Mobil Remediation Trailer

(71) Applicant: Bill Rippetoe, Lafayette, LA (US)

(72) Inventor: Bill Rippetoe, Lafayette, LA (US)

(21) Appl. No.: 13/573,382

(22) Filed: Sep. 13, 2012

(51) Int. Cl. C02F 1/32

(52) U.S. Cl. 210/748.1

(57) ABSTRACT

A remediation process wherein fresh water is pumped into a tank for heating by a heater and pumped thru a KDF filter passed thru a UV Light and passed thru a reactor and stored in a chemical mixing tank wherein a promoter oxidizers is added before the solution is pumped from mixing tank to a heat induced probe placed down hole for the purpose of treating contaminated soil and water.

### FIELD OF THE INVENTION

This invention relates to the environmental remediation of contaminated soil in-situ and with improved mechanical and chemical remediation processes.

### BACK GROUND OF THE INVENTION

Contaminated soil and water has long been a problem resulting from industry processes and chemical spills resulting from oil exploration and other industry run off or industrial accidents.

Clean up of contaminated soil can be a very costly and time-consuming. Many contaminated sites require that the soil be removed to a site where the contaminates are removed by a remediation process and then returned to the original site.

Mobil mounted remediation equipment can also be trailer mounted to assist in cost reduction and to make the remediation process more efficient. Typical remediation equipment may include water separators, filtering systems, and chemical induction systems.

In regard to improvements on the mechanical processes utilized for remediation, one such innovative apparatus includes, a reactor for ionizing and adding additional energy to fluids, thus separating carbon atoms in a more efficient manner.

On the chemical side of the process, Persulfate Oxidation Chemistry is a new emerging technology for the (in-situ) chemical oxidation of chlorinated and non-chlorinated organics. Activator of persulfate to form sulfate radicals is a potent tool for the remediation of a wide variety of contaminants including chlorinated solvents (ethenes, ethanes and methanes), BTEX, MTBE, Dioxane, PCB's and PAH's.

Several new activation technologies now exist to catalyze the formation of sulfate radicals including persutfate combined with chelated metal complexes and persutfate combined with hydrogen peroxide and alkaline persulfate.

The present invention utilizes the latest ion collider reactor technologies and combines the processes with innovative chemical promoters and combines all improvements within a mobile remediation trailer wherein the remediation process can be easily transferred to the required site.

The process is trailer mounted and has a reactor using the well-established principal of cavitation in order to produce hydrogenation of water. Additionally, a tankless hot water process is utilized and a UV light process is used providing further enhancement of fluids that exhibit super critical characteristics that attacks the hydrocarbon molecule breaking down the molecule. The process is defined as designed advanced oxidation process decontamination.

Additionally, a heat induced probe is utilized for effectively working within areas that are below optimum operating temperature and to more effectively address temperature balance.

The improved technology destroys hydrocarbon-based contaminants by converting them into carbon dioxide and water. The process is a form of oxidation that utilizes known oxidant reagents and water produced by a reactor.

The process creates free hydrogen radicals through sono-chemical, mechanical and ionic phenomena. These phenomena create very high localized temperatures and pressures that drive numerous chemical reactions.

The combination of reacted water and contaminant-specific oxidizers accomplish the contaminant destruction, resulting in substantially greater remediation effectiveness than other currently available methods. Comparative process effectiveness maybe judged using the following criteria:

1) Time to completion;
2) Cost effectiveness;
3) Environmental impact;
4) Impact on the subject soil matrix;
5) Post-process disposal requirements; and,
6) Consistent, verifiable, and permanent contaminant destruction below regulatory guidelines.

The technology is applicable and cost effective for both hazardous and non-hazardous contaminants and can be applied to any form of organic pollution including petrochemicals, human and animal waste, Agricultural waste including fertilizers and pesticides, as well as hazardous industrial contaminants, such as Creosote, Perchloroethylene, Tetrachloroethylene, Pentachlorophenols (PCPs), PAH, etc.

The technology is capable of producing positive results well beyond the specific applications of treating soil, sludge, and dredge. Within the soil treatment application, water is passed through the reactor and subsequently introduced, along with other contaminant specific oxidizers, into the contaminated soil. However, the reactor can directly treat polluted media by passing the media through the device.

For example, contaminated ground water or leachate can be passed through a ion collider reactor and be more effectively treated. The treatment system may be used in an ex-situ or in-situ application for destruction of pollutants. The primary application of the technology within the research and development facility will be both an ex-situ and in-situ application.

While my above description contains many specifications, these should not be construed as limitations on the scope of the invention, but rather as an exemplification of one preferred embodiment thereof.

### BRIEF DESCRIPTION OF THE DRAWINGS

FIG. 1 is a diagram of the process configuration.

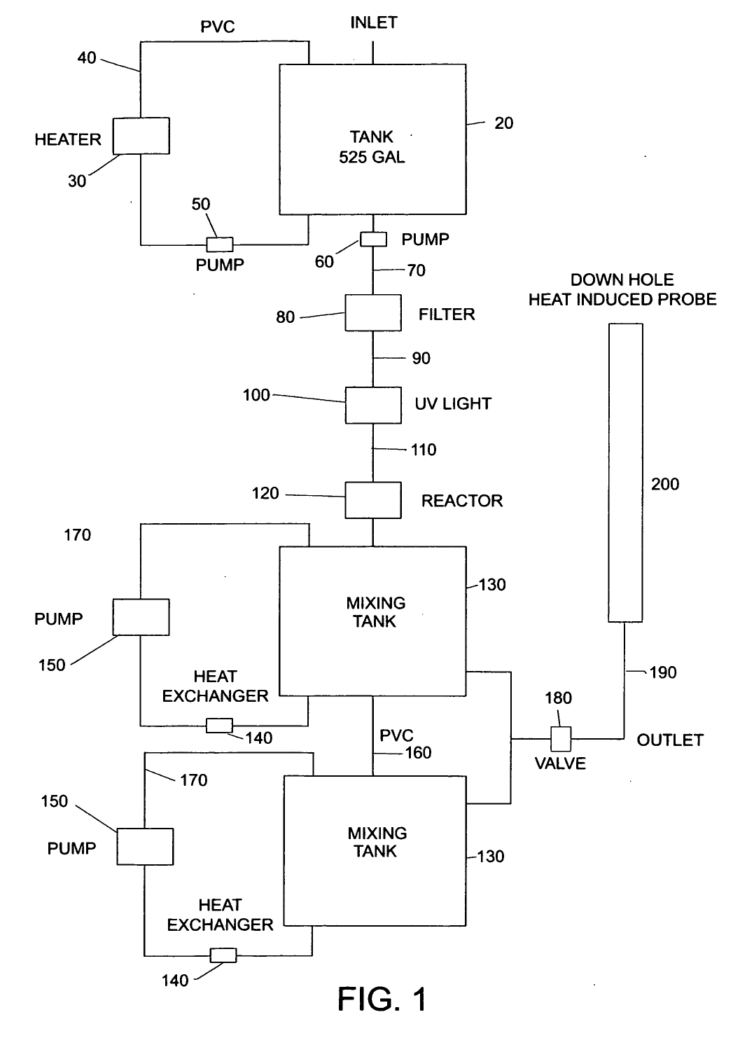

FIG. 2 is a elevational view of a probe

FIG. 3 is a elevational view of a typical installation of a heat probe

### DETAILED DESCRIPTION OF THE PREFERRED EMBODIMENT

In the preferred embodiment of the remediation process 500 gallons of fresh water is brought on board at the rear of the trailer via a fire hose, water hose or rigid piping and held in a 525 gallon tank 20 for heating.

Heating may be accomplished by a propane tankless hot water heater 30 or similar apparatus that continuously circulates the water through PVC piping 40 connected at the bottom of the holding tank.

The water may be moved using a commercially available circulation pump 50 on the inlet side of the Heater. The heater improves kinetic dispersant effect on chemical water blend.

The water is passed through the heating element and then returned to the top side of the holding tank 20. This circulation continues until the water reaches a set or pre-determined temperature based upon specific requirements.

Once the set temperature is reached the water is then transferred by way of a circulation pump 60 out of the holding tank and through PVC piping 70 to a KDF Filter 80.

The water then flows out of the KDF Filter 80 and through PVC piping 90 to an apparatus 100 wherein the water is subjected to UV Light and then passed thru PVC Piping 110 to a reactor 120. The UV Light produces advance oxidation radical hydroxyl energy

The hot water entering the reactor 120 is subjected to cavitation. The reactor 120 may also be know as a ion collider or a cavitation devise and adds energy to the contaminated fluids to enhance the chemical break down.

The preferred reactor is described in a patent entitled “Treating fluids to alter their physical characteristics” U.S. Pat. No. 6,106,787 issued Aug. 22, 2000 or a patent entitled “Improved method and apparatus for separation of particles from liquids” U.S. Pat. No. 5,482,629 issued Jan. 9, 1996.

Cavitation is a process of bubble formation and collapse in a fluid. If the local pressure in a flow field drops below the vapor pressure of the fluid, then some of the fluid will vaporize. The bubbles collapse.

If the time scale for bubble collapse is short, the collapse occurs adiabatically and enormous temperature and pressures (thousands of atmospheres) can be produced.

The enormous temperature and pressure of cavitation damage pumps, propellers and other devices in which cavitation occurs. The reactor promotes cavitation chemistry for enhancement of the remediation process and will de-contaminate chemical bonds unaffected by other processes.

The solution then enters one of two chemical mixing tanks 130 at the front of the trailer. The mixing tanks 130 shall have a heat exchanger 140 and a pump 150 for circulation purposes. The mixing tanks 130 shall be connected by a PVC pipe connection 160.

The mixing tanks 130 will allow for a mix of designer fluids to be added based upon proper evaluation of conditions to determine the required and appropriate oxidizer required. Evaluation will include site geology, hydrology, soil properties, and soil oxidant demand.

A promoter may also be added to mixing tanks 130 and is a choice-of-activation to form superior oxides, hydroxyl radicals, sulfate radical and this can be chemical such as chelated metal activators and improves transportability.

Once all 500 gallons of water is transferred to one of two chemical tanks 130 at the front of the trailer, the process is repeated with the fresh water tank. The hot water in the chemical tanks 130 is kept at the set temperature by using a both tankless hot water heaters by way of heat exchangers located at the hot water heater (heat exchangers are used as to not expose the heater to the chemical).

This process is different than the fresh water tank, because the water is heated through a closed loop system located on the heater itself.

This is accomplished by using a food grade Glycol on the heater side of the system. The glycol is moved using a separate pump on the heater side of the closed loop system.

The water form the chemical tanks 130 are pumped through PVC piping 170 from the bottom of the chemical tank through pumps 150 then trough the heat exchangers 140 and back to the top of the chemical tanks 130. There are two chemical tanks 130 so this process is the same on both chemical tanks.

Once the chemical tanks 130 are full and heater system working, The pump is started to circulate the water. This circulating water also acts as our mixer for the chemical. The heat exchanger 150 maintains the temperature and pump 150 circulating water and chemicals in the tank.

Once set chemicals are added to the chemical tanks 130 and the mixing has taken place, a valve 180 may be used to allow release of the chemical mixture to be pumped out at a controlled volume.

The heated water and chemicals herein after called a slurry is pumped out of the mobile remediation trailer through a PVC pipe 190. The pipe 190 is then connected to a suitable flexible hose that can be connected to a Heat Sink Injection Probe 200.

The Heat Sink Injection Probe 200 is a down-hole injection probe utilized for injecting hot slurry below the frost line of the In-Situ process. The probe has the capacity to alter flow rates that may need to be utilized on a site specific bases.

The flow rate is determined by the amount of slurry to be injected into each injection point. The Heat Sink Injection Probe 200 works from the bottom of the injection point to the top.

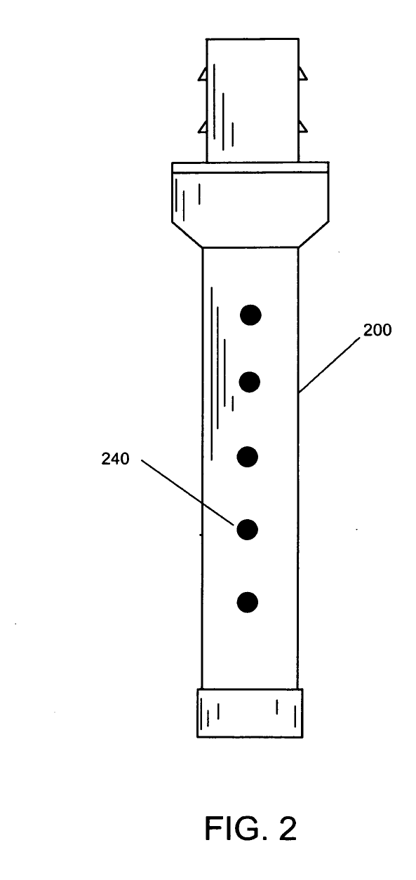

By using this process the Heat Sink Injection Probe utilizes the earth as an insulator to hold the heat for longer periods of time while the injection process is being executed, Shown in FIG. 2.

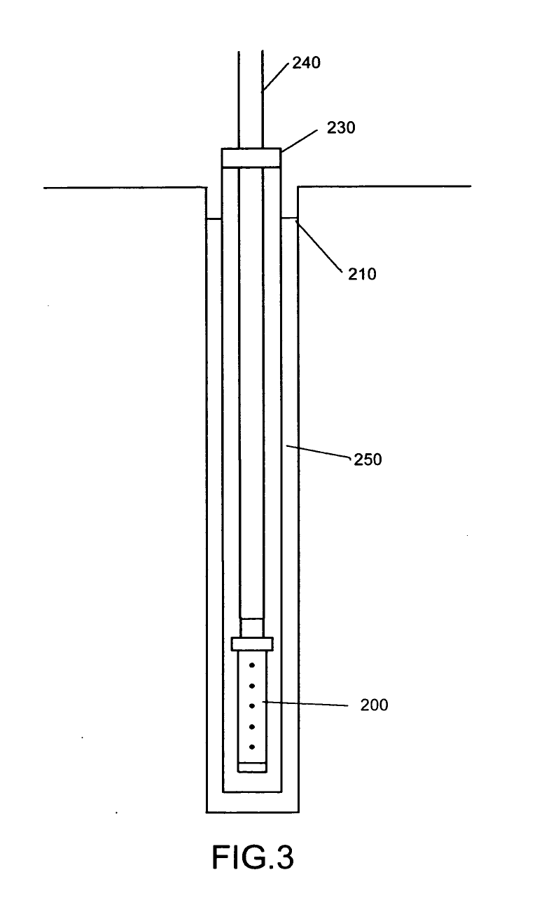

A Bentonite seal 210, Shown in FIG. 3 is placed approximately 6 to 8 inches below surface level around the outside of the injection point screen 220. This seal allows the heat to be trapped within the injection point and to eliminate convection out of pipe to cold climate.

Additionally, a cap 230 can be utilized that is specially designed to allow only the injection hose 240 to pass through, thus insuring that all the heat is held down-hole during the injection process. The Heat Sink Injection Probe 200 shall have a plurality of openings 240, Shown in FIG. 2 for the slurry to enter into the well 250, shown in FIG. 3.

The kinetic energy or the heat contained down-hole depends on it's chemical makeup as well as the mass and temperature of the remediation area. Heat contained within the slurry or treated water is transformed to the lower temperatures by convection or as radiant heat.

Temperature affects activity of chemicals. In our experience in Illinois, Iowa, New York, and Massachusetts, the temperature dropped below 40 degrees, rendering chemicals ineffective. This was corrected by delivery of heat to the bottom of the hole.

This heat, insulated by the earth surrounding, enabled treatment to stay in place for days, which, in turn, allowed longer treatment and shorter remediation time in the cold of winter.

Should some undetected contamination appear that was not discovered in coring testing, the Heat Sink Injection Probe in-situ remediation treatment can be modified in depth to treat at any elevation.

The process can be modified in the oxidation hotspot chemistry process, the chelation mixture, UV light stage length, ionic exchange chemistry, and individual processes or a combination of said treatment process may be adapted at the site.

The improved remediation process included a combination of:

### The Reactor & Catalytic Water Processes

Water is passed through a cavitation reactor 120 that subjects the water to sono-chemical/mechanical phenomena, UV light below 300 nm, and a metal catalyst to produce what will here/after be referred to as “catalytic water”. There act or is a device that both affects the molecular structure and influences the molecular charge of gases and/or liquids.

In its simplest form, the process is accomplished by a metal tube, through which liquids enter the tube and are subjected to engineered hydrodynamics and contact with contaminant-specific metal catalysts. Within the tube, flow dynamics cause the medium, either fluid or gas, to impact the inner surface to the tube. The medium collides with a metal catalyst while simultaneously reaching a point of prescribed pressure, inducing vaporization of the media.

As the media move through pressure gradients are as of locally high temperature are induced. This rapid movement through the pressure gradient coupled with the metal catalyst, causes the media to under go thermal, electrical and sono/chemical reactions generating energy with in the reactor and the contained media. This combination of simultaneous reactions affects the molecular structure and charge of the media in a manner that depending on the original nature of the fluid or gas produces beneficial effects including:
Separation of dissimilar components;
Reduction or elimination of non-homogeneous materials entrained or emulsified within the media;
Greater oxidation efficiencies; and,
Enhanced molecular homogeneity.

Among the critical design criteria incorporated in to the reactor are:

Mechanical pressure utilized in lieu of outside heat sources; maximized hydrodynamics to direct the induced magnetic field back into the media thus directly imparting a charge; material composition of the device including specific metal alloys known to produce catalytic properties, characteristics; and, internal device configuration designed to create specific flow regimes that facilitate the capability of the media to accept charges. The catalytic water possesses many qualities in addition to oxidative qualities most notably that of a surfactant and thus acts as a superior oxidant carrier to penetrate the soil matrix more effectively.

Within the reactor there are at least thirty (30) separate reactions involving the H₂O molecule alone, propagated by the initial dissociation of water among these reactions, hydrogen peroxide and free hydroxyl radicals are produced through a process in which oxygen atoms in D1 state insert rapidly in water through mechanisms including the following:

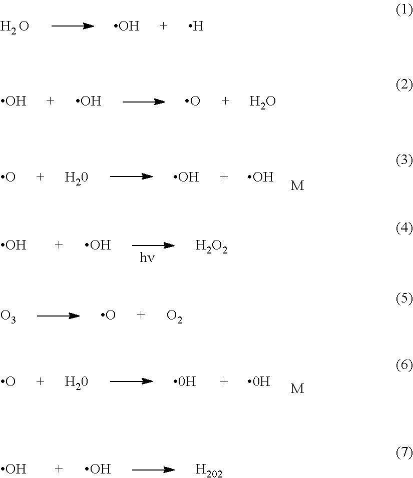

Peroxides so formed may initiate chain decomposition of ozone to hydroxyl and other radicals or may be photolyzed to create hydroxyls. The many H₂O reactions produce Ozone (0₃), di-oxygen (0₂), super oxide ions (O₂⁻) and radicals (.O₂⁻, and its conjugate Acid (HO₂⁻). When hydroxyl radicals oxidize organic compounds in the presence of di-oxygen, super oxide ion (O₂⁻) or its conjugate acid (HO₂⁻) is often formed as intermediates. Super oxide reacts very rapidly with ozone producing more hydroxyl radicals through mechanisms including the following:

O₃+.O₂⁻→.O₃⁻+0₂ (1)

O₃⁻+H₂O→.OH+O₂+OH⁻ (2)

O₃⁻+.OH→HO₂.+.O₂⁻ (3)

All of the above reactions are beneficial to the overall oxidation treatment process. Upon introduction to a slurry, the suspended contaminant particles in the sediments become charged, agglomerate, settle out, or mobilize. As liquids pass through the device, regions of locally high energy density are created. Several phenomena occur, including the following summaries.

### Hot Spot Chemistry Process

The reactor 120 causes very high localized temperatures and pressures in the region of media vaporization. These high temperatures and pressures drive numerous chemical reactions. There actions cause the water to dissociate into hydrogen atoms and hydroxyl radicals. The radicals react in a variety of ways, depending on the concentration and chemical composition of the contaminants within the media.

An extensive reaction is the formation of hydrogen peroxide from their combination of two hydroxyl radicals. The peroxide, as well as the heat and pressure, serve to crack higher molecular weight species to smaller fragments. This process continues throughout treatment to create the mineralized end products of CO₂ and water.

### Surfactant Chemistry Process

In addition to forming peroxide, some hydroxyl radicals react with hydrocarbons to form hydrocarbon free radicals. The hydrocarbon free radicals react with other hydrocarbons to form polymeric materials, forming chains terminated with a hydroxyl group. The hydrocarbon radicals can also react with dissolved oxygen forming an alkyl/peroxy radical. These molecules act as surfactants, which in turn can act to liberate hydrocarbon material from solid or semi-solid matrices, as well as facilitate both additional chemical reactions and separation of the solids from the liquid matrix.

### Catalytic Chemistry Process

Locally high temperatures and pressures within the reactor also induce an electrical discharge from the metal surface of the reactor. Metals act as a catalytic surface facilitating the hydrocarbon-cracking affect of surfactants, high temperature and pressure, and hydroxylation reactions.

### Acoustical Wave Propagation Process

Both hot spot chemistry and electrical discharges are confined to relatively small fractions of the fluid volume. The pressure waves induced by the reactor, however, can propagate through the fluid. One result of these pressure waves is to affect the growth and sedimentation of particles in the fluid. The pressure waves cause sinusoidal variations in the particle velocities and driven by these time varying velocities, particle collision and agglomeration rates increase and the resulting larger particles can more effectively separate from the fluid.

### The Oxidation Process

Standard and/or market available oxidation techniques for the removal destruction of hydrocarbon contaminants have been commercially utilized for decades. The available literature supporting the effective use of oxidation for hydrocarbon destruction is extensive and the mechanisms and by products of chemical oxidation are well documented by many investigators.

The subject technology is a variant of chemical oxidation made incrementally more effective by the introduction of catalytic water produced by a proprietary reactor. The following discussion will explain what one may perceive as the most significant aspects of and considerations within the subject technology, while comparing the technology with the same aspects and considerations associated with standard oxidation processes.

More specifically, the following will address and compare:
Effect of Soil matrices, oxidant consumption, and process optimization factors
Reaction mechanisms and toxic daughter products
Oxidant variants, by products and process conditions
Microbial Sensitivity
Comparative incremental increases in effectiveness of the subject technology

The bulk of literature and supporting research on chemical oxidation processes have focused primarily upon both in-situ and ex-situ applications. As mentioned, the subject technology will be utilized in-situ within an ex-situ application. Nevertheless, discussions of the in-situ application of chemical oxidation serve to inform broader comparative discussions of the proposed ex-situ application and its efficacy.

Effect of Soil Matrices, Oxidant Consumption, and Process Optimization Factors with respect to soil matrix considerations, the most prominent factors addressed by the available literature include:

Oxidant demand and consequent process effectiveness reductions; and,
Adjective and dispersive transport.

In-situ chemical oxidation (ISCO) has been proven effective, and its efficacy is thus well suited for the oxidation of chlorinated solvents and hydrocarbon contaminants in general, as demonstrated with sandy sediments in laboratory column studies (Schroth e tal, 2001; Huang e tal, 2002), in laboratory 2D box studies (Conrad e tal, 2002; Mackinnon and Thomson, 2002), as well as in the field (Nelson e tal, 2001; McGuire et al., 2006).

However, the knowledge with applications in low permeable media, such as clays where diffusion is an important transport mechanism, is more limited. Investigation of the difficulties with ISCO applications in low permeable environments serve to high light the incremental efficiencies obtained within the subject technology.

Successful application of ISCO requires good contact between contaminant and oxidant. However, due to decreased advective/dispersive transport in low permeable media, ISCO performance maybe impaired by consumption of oxidant from reactions with a variety of non-target sedimentary reductants, such as organic matter and/or in organic species, thereby decreasing the amount of oxidant available to react with the contaminants.

The consumption of oxidant by the sedimentary reductants is referred to as the natural oxidant demand (NOD) and is expressed as the mass of oxidant consumed per mass of dry solid. Both organic and inorganic species in the subsurface sediment contribute to the NOD, where organic carbon is found to be the primary reactive species with regard to the total oxidant consumption in the reaction with the sediment (Hood et al., 2002; MacKinnon and Thomson, 2002).

However, the sediment in low permeable media does not generally act as an instantaneous sink for oxidant(s). The consumption of oxidant by reaction with sedimentary reductants is the result of several parallel reactions, during which the reaction between contaminant and oxidant occurs. The long-term consumption of oxidant and oxidation of target contaminants cannot be described by a single rate constant. However, a first order reaction is observed in the first hours of contact for a number of beneficial oxidation reactions. Application of low oxidant concentrations has been found to oxidize hydrocarbon contaminants, even though the oxidant was consumed quickly by reaction with the sediment.

Studies show that relatively low oxidant concentrations can oxidize up to 50%+ of target contaminants, even though the oxidant within these studies is consumed within the first two hours of introduction, Further showing that reductants, including competing reductive sediments, do not act as an instantaneous oxidant sink and that oxidants react simultaneously with target contaminants and competing reductants (Honning etal., 2007; Mumford etal., 2005). This phenomenon has been shown to occur due to faster reaction rates for the oxidation of target contaminants, as opposed to reaction with reductants, and because the NOD does not need to be met fully before contaminants are oxidized.

Though possibly Counter intuitive, the total oxidant consumption (in permanganate studies) increases with Higher initial oxidant concentration for all sediment types, implying that a fixed NOD Value cannot be assigned to any sediment (Greenburg etal., 2004; Crimi and Siegrist, 2005; Xu and Thomson, 2006). Further, studies have shown that the rate constants increase with increasing temperature, with the rate constant twice as high when the temperature increases from 10 degrees to 20° C. (Daiand Reitsma, 2002b; Huang etal., 2002c).

Setting the context for a comparative discussion of ISCO and the subject technology, one might summarize the factors above as the competition between effective Contaminant contact and the elapse of time associated with dispersion rates enabling competitive oxidant consumption. As with ISCO applications described above, low permeable media (e.g., compact clays) present the greatest challenge to effective ex-situ oxidative destruction of entrained hydrocarbon contaminants. However, with in the proposed ex-situ application of the subject technology, pre-processing of the subject contaminated soils, particularly compact clay matrices, effectively eliminates dispersion rate considerations.

Prior to treatment, all soil is pre-processed to remove foreign matter (i.e., large rocks, boards, cans, etc.) and then further processed to create a uniform particle size, throughout all material staged for treatment, of less than ⅜ inch. Although clays can be resistant to such pre-processing, the technology has been repeatedly successful at producing a uniform granular matrix from high water content, highly plastic, clay feed stock. The introduction of catalytic water (and its surfactant qualities, discussed above) as the carrier for the specific oxidant regime significantly increases dispersion throughout the processed/small granular matrix and enables direct contact with a substantial percentage; if not a 100% of contaminant molecules! Additionally, the introduction of outside heat sources, which maintain the subject soil above 20° C., significantly increase reaction rates and treatment effectiveness.

Finally, as revealed in the above discussion of ISCO applications, organic matter (including organic carbon and or sedimentary organic matter (i.e., original plant tissue, humus, etc.) competes for the consumption of oxidant. The rate of oxidation of dissolved entrained hydrocarbon, however, is independent of the presence of sediment or organic matter in the system. First order rate constants for contaminant reaction with oxidant are considerably higher than the rate constants for competitive oxidant consumption, suggesting that the oxidation of dissolved entrained hydrocarbon is quick and effective when no oxidants are present in the vicinity of the target contaminant (Henning etal., 2007a; Gates-Anderson etal., 2001; Allen etal., 2002; Balba etal., 2002; Chambers etal, 2000; Smith etal., 2006). This suggestion has consistently been confirmed in numerous field applications of the subject technology. Due to effective soil management techniques, primarily represented in pre-processing and the staging of relatively uniform particle size materials and subsequent effective oxidant contact, increased and/or variable organic matter content does not adversely affect the efficacy of the subject treatment technology. [a broader statement about unnecessary Demo of varying soil matrices

### Reaction Mechanisms and Toxic Daughter Processes

The reaction mechanisms for hydrocarbon oxidation are well understood and documented in literature. As oxidation reactions progress to completion, oxidized organic compounds mineralize to produce CO₂ and H₂O. As a representative cross-section, the following reactions and their stoichiometric equations follow (EPA, 2004):

| Petroleum Hydrocarbon | Oxidation Reaction |
|---|---|
| MTBE | C₅H₁₂O + 7.5O₂ → 5CO₂ + 6H₂O |
| Benzene | C₆H₆ + 7.5O₂ → CO₂ + 3H₂O |
| Toluene | C₆H₅CH₃ + 90₂ → 7CO₂ + 4H₂O |

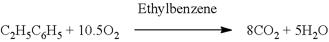

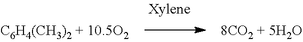

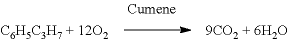

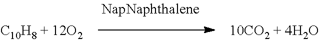

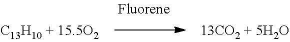

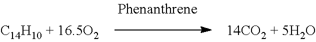

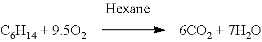

Toxic daughter products are possible in ISCO applications, but these products are generally less toxic, more biodegradable, and more mobile than the parent compound (EPA, 2006). Toxic daughter production is almost exclusively due to inadequate dosage and/or advection/dispersion rate decreases and cessation. Particularly in the vicinity of the diffusion front, as advection dispersions lows and or ceases, in complete oxidation may occur and, thus toxic daughter products may be produced. However, in most cases if an adequate oxidant dosage is applied, the reactions proceed to completion and the end products are reached quickly. Contaminants amenable to treatment by ISCO include the following (ITRC, 2005):
Benzene, toluene, ethylbenzene, and xylenes (BTEX);
Methyl tert-butyl ether (MTBE);
Total petroleum hydrocarbons (TPH);
Chlorinated Solvents (ethenes and ethanes);
Polyaromatic hydrocarbons (PAHs);
Polychlorinated biphenyls (PCBs);
Chlorinated benzenes (CBs);
Phenols;
Organic pesticides (insecticides and herbicides); and,
Munitions constituents (RDX, TNT, HMX, etc.).

The supporting literature is clear that oxidation processes fully mineralize contaminants of concern (COCs) and their toxic daughter products intermediaries in ISCO applications. However, the following considerations and conditions can limit ISCO process effectiveness.

Sufficient contact and oxidant—as demonstrated throughout the discussions above, When COCs come into contact with sufficient oxidant, the contaminants are fully mineralized to CO₂ and H₂O, with no toxic by products. However, acceptable COC destruction is dependent upon sufficient contact and oxidant availability.

Follow-up treatment even when ISCO applications fail to fully mineralize COCs and/or toxic daughter products, it is clear that remaining COCs and toxic daughter products will fully mineralize to CO₂ and H₂O in the presence of sufficient follow-up treatment. The primary factor in the follow-up treatment scenario thus becomes a consideration of expense and economic feasibility, not the permanent presence of COCs or toxic daughter products (Huling etal., 2006).

Treatment conditions & process inefficiencies—ISCO applications encounter many subsurface conditions that are not ideal and can create process inefficiencies if these conditions are not properly addressed. These process inefficiencies can enable the accumulation of toxic daughter products intermediaries. Process inefficiencies are generally associated with improper oxidant selection, incomplete dispersion throughout the contaminant plume, pH and temperature conditions, and oxidant depletion (Huling etal., 2006; [and others]).

The primary factors revealed in the prior section supporting the greater effectiveness of the ex-situ application of the subject technology as compared with ISCO applications (i.e., soil pre-processing creating a uniform granular matrix, effective dispersion and surfactant qualities of the treatment regime, maintenance of reasonably optimum temperature, and adequate availability of oxidant throughout the treatment period), are the same factors that enable the subject technology to consistently and reliably destroy COCs and any daughter products below acceptable and guideline toxicity levels.

The literature establishes that where oxidant COC contact occurs in the presence of sufficient oxidant, reactions proceed to completion resulting in full mineralization to CO₂ and H₂O. The literature further establishes that when COCs are destroyed below acceptable levels, daughter products are generally less toxic, more biodegradable, and more mobile (and, thus easier to attack) than the parent and, when in the presence of sufficient oxidant, do not accumulate and are destroyed below toxic acceptable levels. Field-scale experience utilizing the subject technology confirms these findings and is further verified by third-party EPA-certified environmental laboratory analytical reports.

Dispersion of oxidant throughout the contaminated soil matrix occurs rapidly and completely, as the treatment regime is introduced into and saturates a six-inch layer of target soil material comprised of ⅜ inch or less particle size continuously passing on a radial stacker.

The elimination of dispersion front complications enables efficient use of reagent agent and thus, superior economics, with the elimination of opportunity for contaminant rebound, since no available contaminants remain for back flow migration. This treated material is then staged for undisturbed “curing”, allowing oxidation reactions to proceed through completion over a 72-hour period.

Further enhancing treatment effectiveness and superior economics, laboratory tests are performed on the subject contaminants prior to treatment, identifying COC concentrations and determining the prescribed treatment regimen that assumes full mineralization throughout the oxidation pathway. Variable combinations, concentrations of short and long chain hydrocarbons are immaterial to process effectiveness. As with all oxidation processes, the subject technology is non-selective and does not discriminate among the specific hydrocarbons present in the subject soil.

### Oxidant Variants, By-Products & Process Conditions

There are several oxidants used in ISCO applications. The most current literature focuses on four or five primary oxidant systems that, additionally, aid in better understanding of the combined oxidative action of the subject technology. Following is a summary discussion of each ISCO oxidant system including Permanganate, Hydrogen Peroxide and the variant Fenton System, Persulfate, and Ozone.

### In-Situ Permanganate Oxidation Process

ISCO application using permanganate is perhaps the best understood/System in part due to its wide spread prior and continuing usage. The general reaction in the widest pH range (pH3.5-12) is:

MnO₄⁻+H₂O+3e⁻

→MnO₄⁻(S)+OH—

As shown, the primary process residual of the reaction is a solid non-toxic precipitate, MnO₂. Other reactions occur in strongly acidic and alkaline conditions, but will not be discussed, as the subject technology is not normally applied under extreme pH conditions. Overall, permanganate oxidation involves various electron transfer reactions, but is generally considered independent of pH in the range of 4 to 8 (EPA 2006).

Permanganate ISCO systems are indicated in a wide range of hydrocarbon-based contaminants and generally proceed at a relatively slow reaction rate as compared to the other oxidant classes. Permanganate also demonstrates greater transport distances and persistence in subsurface environments.

This persistence also contributes to greater diffusive transport into low-permeability material (e.g., clays) (EPA 2006; Struse et al., 2002a). Natural oxidant demand (NOD) is generally high, but as discussed above, oxidative actions and NOD competition proceed independently, enabling effective mineralization of target contaminants.

There are two forms of remediation grade permanganate, potassium permanganate (KMnO₄) and sodium permanganate (NaMnO₄). A few cases of reduced subsurface permeability due to excess MnO2 precipitation have been observed. These cases have been exclusively associated with the use of the potassium form of permanganate.

It has been fairly well established that these instances of permeability loss are due to improper reagent management (e.g., improper mixing, temperature control, filtering, etc.). Permeability reduction is rarely reported and can largely be avoided by adhering to Design and operational guidelines (EPA 2006; the Chambers etal., 200b; Streusel etal., 2002a; Schnarr etal., 1998; Mott-Smith etal., 2000; Nelson etal., 2001). Sodium permanganate is produced as a solution and, therefore, does not precipitate and no documented cases have been found where permeability reductions occurred while using NaMnO4.

As mentioned, considerable field experience has been obtained from the application of this technology within a wide range of sites and conditions. The chemistry involved in the ISCO application of permanganate is relatively simple and the information and guidelines needed for its effective, economical, and safe use have been well-documented and disseminated.

### In-Situ Hydrogen Peroxide and Fenton Oxidation Process

Hydrogen Peroxide (Peroxide) has many industrial applications and has been used for ISCO applications for decades (Watts e tal., 1990; Tyre e tal., 1991; Gatesand Siegrist, 1995; Gates-Anderson e tal., 2001; Cline e tal., 1997; Kauffman e tal., 2002; Chow e tal., 2002). Peroxide can be utilized in either direct or indirect oxidation, but reaction kinetics are not generally fast enough before peroxide decomposes. The addition of ferrous iron (Fe2+ dramatically increases oxidative strength through the formation of hydroxyl radicals and superoxide radicals in the following Fenton's reaction:

H₂O₂+Fe²⁺→Fe³⁺+.OH (1)

H₂O₂+Fe³⁺→Fe²⁺.O₂⁻+2H⁺ (2)

.O₂+Fe³⁺→Fe²⁺+O₂(g)+2H⁺ (3)

Peroxide in ISCO applications. Many sites contain naturally occurring form so from that serve as the predominant source of Fe²⁺ catalyst in the Fenton's cycle. No information Indicates persistence of acidic conditions that the above formulas indicate. Natural buffering systems present in the subsurface soil mitigate long-term persistence (EPA 2006). A wide range of hydrocarbon-based contaminants are vulnerable to fast destruction by peroxide reactions and resulting hydroxyl and superoxide radicals.

Used alone in ISCO applications, however, peroxide Fenton reactions maybe incomplete due to the relatively short life of the oxidant regime and subsequent short diffusive front. Other concerns ISCO applications of peroxide Fenton reactions include dense non-aqueous phase liquid (DNAPL) and other contaminant mobilization, highly exothermic reactions creating dramatic temperature increases, and 02 gas accumulations and resulting fire and explosion risks. Improvements in the practice of peroxide Fenton based ISCO have contributed to a significant reduction in the see exposures however; and many of these phenomena actually create benefits when managed properly (discussed below in comparison with the subject technology).

### In-Situ Ozone Oxidation Process

Ozone action is a common industrial effluent and wastewater treatment and is a very common municipal water treatment technology (Marley etal., 2002; ITRC, 2005). The use of ozone in ISCO remediation applications has evolved over the last 10 to 20 years and is generally applied as a vadose zone gas in injection or through sparging below the water table (ITRC 2005; EPA 2006). There generally is no process residual produced by variable reactions that typically proceed according to the following mechanisms in either a direct reaction or an indirect O₃ composition:

### Direct

O₃+CX+H₂O→2CO₂+2H++X (1)

Indirect

O₃+H₂O→O₂+2.OH (2)

2O₃+H₂O₂→3O₂+2.OH (3)

2O₃+3H₂O₂₋→4O₂+2.OH+2H₂O (4)

The indirect approach works through the formation of hydroxyl radicals, which are highly reactive and possess a high oxidation potential. Due to the relative instability of hydroxyl radicals and the high reactivity and instability of ozone itself, ozone is generated on-site. This can be accomplished by subjecting O₂ gas (available in the surrounding air) to electrical charge or UV irradiation, where O₂ molecules split to react quickly, forming O₃ in concentrations of 1% to 10%.

Contaminant oxidation occurs primarily through two pathways: 1) the diffusion and volatilization of contaminants into subsurface O₃ channels where gas-phase oxidation reactions occur; and, 2) the diffusion of O₃ into the aqueous phase where contaminant oxidation reactions occur.

Due to low Dissolved concentrations of 0₃ in ground water and poor transport to O₃ bubbles through the subsurface soil matrices, long-term delivery of O₃ into the subsurface zone is required for sufficient O₃ delivery and oxidation. Direct O₃ oxidation is most effective on compounds with functional groups that are especially reactive toward electrophylic (i.e., O₃) reactants (e.g., phenols, PAHs, non protonated amino groups, into compounds, etc.).

Indirect ozonation utilizing the more reactive hydroxyl radical will effectively attack molecules containing less reactive functional groups, such as aliphatic hydrocarbons, carboxylic acids, benzene, PCE, TCE, etc. Of note are laboratory studies indicating that the addition of H₂O₂ to O₃ in water increases the oxidative capabilities of the treatment system.

Increased rates of contaminant oxidation have been reported for MTBE, TCE and PCE when 0₃ is combined with H2O2 (Mitani e tal., 2002; Glaze and Kang, 1988; Clancy etal., 1996). Currently, there is no information on the field ISCO application of co-injected H₂0₂ and 0₃ (EPA 2006). Primary concerns during ISCO applications of ozone include fugitive emissions of ozone gas, contaminant mobilization, unpredictable diffusion pathways, and accumulation of O₂ gas in confined spaces.

### In-Situ Persulfate Oxidation Process

The use of persulfate for ISCO applications has emerged within the last 5 to 10 years. Persulfate salts, the most common of which is sodium persulfate, dissociate in solution to form the persulfate ion (S₂O₈²⁻). Persulfate ion is a strong oxidant and can destroy many contaminants of concern.

S₂O₈²⁻→2.SO₄⁻ (1)

S₂O₈2⁻+Fe²⁺→Fe³⁺+.SO₄⁻+SO₄²⁻ (2)

S₂O₈²⁻+→2.SO₄⁻ (3)

SO₄⁻+H₂O→.OH+HSO₄₋ (4)

SO₄⁻+Fe²⁺→FE³⁺+.SO₄⁻+SO₄²⁻ (5)

Persulfate is an attractive oxidant because it persists in the subsurface can be injected at high concentrations, can be transported in porous media, and will undergo density driven and diffusive transport into low-permeability materials. Persulfate oxidation is moderately sensitive to pH conditions (EPA 2006).

As indicated in the above reactions Fe²⁺ is the most common catalyst and maybe supplied by naturally occurring ferrous iron. (Sperry et al., 2002). Because Fe²⁺ is both the chain-propagating and the chain terminating reactant, a balance must be achieved between additions of sufficient Fe to accomplish sulfate radical production and excessive Fe, which may result in elevated sulfate radical scavenging. Various methods have been studied to ensure that Fe remains in solution, as Fe degrades with time and distance, due to iron precipitation in buffered soil (ITRC, 2005).

Persutfate oxidation is effective for a wide variety of hydrocarbon-based contaminants, with one study evaluating its effectiveness on 66 organic compounds (FMC, 2005). Heat-assisted persutfate oxidation is rapid and its use in the oxidation of competing organic carbon prior to introduction of other oxidants has been suggested (Liang etal., 2001). However, Persutfate does not appear to react as readily with soil organic matter as permanganate, suggesting a balance between the two oxidants may beneficially reduce oxidant demand for an overall treatment regime (Brown and Robinson, 2004).

### Microbial Sensitivity Process

Naturally occurring microbes are sensitive to many of the changes and conditions that occur during oxidation applications. Localized decline in microbial activity will result from direct contact with oxidants.

Microbe populations that are insensitive to oxidation conditions will either remain unchanged or may respond favorably to changes created by oxidation applications. The length of time for microbial rebound after oxidation applications is no uniform among the wide variety of micro-organisms present in surface and subsurface soil formations. However, after sufficient time (hours to months, depending on the organism) subsequent to oxidation treatment, microbial populations, activity, and rate of natural biodegradation increase, in some cases to levels above pre oxidation conditions.

Proposed theories for these observed microbial rebounds include improved bio-availability of trace constituents, lower concentrations of challenging chemicals, increased simple substrate availability resulting from contaminant and/or natural organic matter oxidation destruction, less competition for available nutrients and substrate, removal of microbial predators, elevated temperatures, and greater availability of terminal electron acceptors (TEA). No cases have been found where treated media have been sterilized or where microbial activity has been permanently inhibited (EPA, 2006; Allen and Reardon, 2000).

Microbe-beneficial TEAs include, manganese (Mn (IV)), ferric iron (Fe (III)), sulfate (SO₄²⁻), CO₂, O₂, and NO₃⁻. Thus, there are several mechanisms in which ISCO (and oxidation applications, generally) could be beneficial to natural attenuation. Acidification resulting from some oxidation application amendments or reaction by products may temporarily lower the pH and increase bio-availability of some microbial nutrients.

The Injection of each of the above discussed oxidants results in the addition of various TEAs, including dissolved oxygen from hydrogen peroxide and ozone, SO₄²⁻ from persulfate, and Mn⁴⁺ from permanganate, and (to a lesser degree) Fe during Fenton's addition. While oxidant injection is intended for immediate contaminant oxidation and could result in a short-term, localized microbial inhibition, it also introduces TEA's into the treated media. It has been suggested that shifts in pre-dominant terminal election accepting process from an inefficient to more efficient processes, such as aerobic biodegradation and/or Fe, Mn, and SO₄²⁻ reduction provides a sustained long-term source of beneficial TEA (EPA, 2006, Huling etal., 2002).

### Comparative Incremental Effectiveness

The above discussion (and a more in-depth survey beyond the scope of this document) of the primary oxidants in ISCO applications reveals advantages and disadvantage so each stand-alone application. A primary and unique feature of the subject technology and its application in-situ and ex-situ environment is the effective combination of each of the above oxidation pathways in one treatment process. The reactor-produced catalytic water creates ozone on site and couples that ozone with the enhancing effect of peroxide, hydroxyl radicals, superoxide radicals and other beneficial intermediaries.

Metal Catalysts in the reactor and naturally occurring iron create modified Fenton's reactions and their beneficial oxidative effects. The addition of this catalytic water with contaminant-specific reagents of permanganate and/or persutfate further enhance oxidation effects, with the added benefit of surfactant action and resulting diffusion efficiencies. A disadvantage common to all stand-alone ISCO oxidant applications is the decreased economic feasibility of follow-up treatment(s) and/or continuous oxidant feed systems necessary to continue diffusion rates and available oxidant.

In contrast, the subject technology creates certain oxidants and the ex-situ application ensures effective and fully diffusive contact with contaminants of concern (COCs) in a market efficient, very economical manner. Literature indicates that greater ISCO efficiency occurs in source zones where high concentrations of COCs are present.

The feasibility of treating relatively low dissolved concentrations or organic contaminants may not be as favorable due to the economics of introducing enough oxidant in the ISCO environment to penetrate a large subsurface formation (EPA, 2006). Applications of the subject technology in ex-situ environments confirm the relative ease of destroying high COC concentrations. Remediating relatively low COC concentrations (yet, above guideline levels) is precisely where the subject technology excels, by economically and consistently destroying low-level COCs concentrations below guideline levels.

The economics of the system extend beyond simple monetary considerations, as the subject technology reduces resource consumption in its effective utilization and/or minimization of oxidants, energy, water, process residuals, environmental impact, etc.

The ex-situ application directly eliminates many of the primary disadvantages of ISCO applications. Possible permanganate process residual (MnO₂), if produced at all, cannot reduce permeability of the subject soil matrix. Applied in an ex-situ environment, MnO₂ is dispersed with in the matrix, eliminating the possibility of transport blockage through build-up, plugging, crusting, scaling and other processes. Problems associated with gas production and build-up are eliminated in the ex-situ environment, as off-gassing of O₂ is not complete without fire and explosion potential and dangerous pressure accumulations do not occur.

Volatile organic compounds (VOCs) are significantly reduced, as complete diffusion and availability of oxidant in the ex-situ environment mineralizes COCs, intermediaries and daughter products below guideline levels. Thus VOCs, if any, do not have the opportunity to form to any appreciable degree. If VOCs do form, their concentrations are orders of magnitude (fractions of parts per billion) below any guideline for the protection of human health, wild life and/or the environment (VOC claims have been confirmed by regulatory agencies and internal VOC testing).

Although some mention of O₃ fugitive emissions have been raised in the ISCO application of ozone, the amount of ozone utilized in the subject process does not approach the harmful levels warranting concern and the O₃ oxidant is completely consumed during the process. With in each ISCO application, potential mobilization of DNAP Land other contaminants have caused concern primarily associated with possible groundwater contamination and contaminant rebound phenomena. However, in the ex-situ environment, contaminant mobilization is exactly the type of phenomenon desired, as release and mobilization subjects COCs to effective mineralization, without possible groundwater involvement and/or COC rebound into the treated matrix.

### Kinetic Energy Process

By utilizing a heat induced probe to deliver the treated slurry or treated water the remediation process additionally utilizes kinetic energy thus allowing the other chemical processes utilized to perform at optimum capacity and efficiently.

As compared to other remediation processes, the subject technology consistently, verifiably, and permanently destroys contaminants below guideline levels, within 72 hours, without creating adverse environmental impact or adverse impact on the subject soil matrix. The subject technology is economically efficient and produces permanent COC removal, with a minimum of post-process disposal requirements.

It maybe thus seen that the objects of the present invention set forth, as well as those made apparent from the forgoing description are efficiently attained. While preferred embodiments of the invention have been set forth for purposes of disclosure, modifications of the disclosure embodiments of the invention as well as other embodiments thereof may occur to those skilled in the art accordingly. The appended claims are intended to cover all embodiments that do not depart from the spirit and scope of the invention.

I claim:

1. A remediation process wherein 500 gallons of fresh water is pumped into a 525 gallon tank for heating;
Heating is accomplished by a propane tankless hot water heater
The heated water is pumped to a KDF Filter.
The heated water is then passed through a UV Light
The heated water then passes through a Reactor producing cavitation
The treated hot water solution is pumped to a chemical mixing tank
A promoter of appropriate oxidizer is mixed with treated hot water.
Mixed solution is pumped from mixing tank to a heat induced probe placed in a down-hole well for the purpose of remediation and treating of contaminated soil and aquifer.

2. A remediation process wherein 500 gallons of fresh water is pumped into a 525 gallon tank for heating;
Heating is accomplished by a propane tankless hot water heater
The heated water is pumped to a KDF Filter.
The heated water is then pumped through a UV Light
The hot water is then pumped through a Reactor producing cavitation
The treated hot water solution is pumped to a chemical mixing tank
A promoter of appropriate oxidizer is mixed with treated hot water.
Pumped down hole on pre-engineered spacing of 5 to 7 foot opening though out the plume area of contaminated area.

3. A remediation process wherein 500 gallons of fresh water is pumped into a 525 gallon tank for heating;
Heating is accomplished by a propane tankless hot water heater
The heated water is pumped to a KDF Filter.
The heated water is then pumped through a UV Light
The hot water is then pumped through a Reactor producing cavitation
The treated hot water solution is pumped to a chemical mixing tank
A promoter of appropriate oxidizer is mixed with treated hot water.
Sprayed on contaminated soil to flow down to aquifer.
